(19) United States
(12) Patent Application Publication
(10) Pub. No.: US 2005/0116932 A1
(43) Pub. Date: Jun. 2, 2005

(54) Swipe mouse

(76) Inventor: Kia Silverbrook, Balmain (AU)

Correspondence Address: SILVERBROOK RESEARCH PTY LTD, 393 DARLING STREET, BALMAIN, 2041, AU

(21) Appl. No.: 10/503,922

(22) PCT Filed: Feb. 12, 2003
(86) PCT No.: PCT/AU03/00146

(30) Foreign Application Priority Data
Feb. 13, 2002 (AU) PS 0495

(51) Int. Cl. G09G 5/08

(52) U.S. Cl. 345/163

(57) ABSTRACT

A mouse pointing device for use with a personal computer includes a motion sensor serving to relay positional data from the device to a computer to effect motion of a graphic pointer on a monitor. A printer located within the housing receives print image information from the computer. The printer is configured to print an image on print media external to the device as the device traverses the media The motion sensor provides positional data of the device relative to the print media to the printer during the printing operation.

### FIELD OF INVENTION

The following invention relates to computer pointing device technology and printing. More particularly, though not exclusively, the invention relates to a mouse having a built-in printer.

### BACKGROUND OF THE INVENTION

Modem desktop computers and their associated peripheral devices take up a lot of desk space. Desktop scanners, printers, monitors, keyboards and mouse pointing devices all demand desk space. Particularly monopolizing of desk space are desktop printers and mouse pointers. Mouse pointers themselves are quite small, but they require a large area of desk space in use.

The mere incorporation into a mouse body of a known printer device would not result in a compact, easily manoeuvrable mouse. This is because prior art printers incorporate a supply of print media and employ a print media feed mechanism to transport the print media past the printhead to effect printing onto the print media. Moreover, known printers, having a supply of print media, are large and heavier than would be desirable in a mouse pointing device.

### SUMMARY OF THE INVENTION

In accordance with the invention, there is provided a mouse pointing device comprising:
a housing;
a motion sensor mounted to the housing and serving to relay positional data from the device to a computer so as to effect motion of a graphic pointer on a monitor associated with the computer; and
a printer located within the housing and configured to receive print data from the computer, the printer being configured to print an image, based on the print data, onto print media external to said housing as the housing traverses said media, said motion sensor providing positional data of the housing relative to said print media to the printer during printing.

Preferably, the housing further includes an ink supply for storing ink and supplying it to the printer. More preferably, the ink supply comprises a removable ink cartridge.

In a preferred form, the printer includes a drop-on-demand inkjet printhead including a plurality of ink ejection nozzles.

Preferably, the housing also includes a print controller including a computer processor into which the print data can be input and converted into a sequence of drop ejection control signals. In this case, the print controller operates the ink ejection nozzles in accordance with the drop ejection control signals to cause printing on the print media at a rate determined using a measured relative speed between the printhead and the print media.

Preferably, the motion sensor includes a light source to emit light onto a surface on which the device is used. Light reflected from the surface passes through a lens to a CCD chip.

It is particularly preferred that the printer includes a printhead fabricated at least partially using microelectromechanical processes.

Co-Pending Applications

Various methods, systems and apparatus relating to the present invention are disclosed in the following co-pending applications filed by the applicant or assignee of the present invention simultaneously with the present application:

| | | | | | |
|---|---|---|---|---|---|
| AP39 | AP43 | AP44 | AP46 | AP47 | AP48 |
| AP49 | AP50 | AP51 | AP52 | AP53 | AP55 |
| AP58 | AP60 | AP61 | AP62 | AP63 | AP64 |
| AP65 | AP66 | AP67 | AP68 | AP69 | AP70 |
| AP71 | AP77 | AP78 | AP79 | | |

The disclosures of these co-pending applications are incorporated herein by cross-reference. Each application is temporarily identified by its file reference. This will be replaced by the corresponding PCT Application Number when available.

RELATED PATENT APPLICATIONS AND PATENTS

| US6,227,652 | US6,213,588 | US6,213,589 | US6,231,163 |
|---|---|---|---|
| US6,247,795 | US6,394,581 | US6,244,691 | US6,257,704 |
| US6,416,168 | US6,220,694 | US6,257,705 | US6,247,794 |
| US6,234,610 | US6,247,793 | US6,264,306 | US6,241,342 |
| US6,247,792 | US6,264,307 | US6,254,220 | US6,234,611 |
| US6,302,528 | US6,283,582 | US6,239,821 | US6,338,547 |
| US6,247,796 | US09/113,122 | US6,390,603 | US6,362,843 |
| US6,293,653 | US6,312,107 | US6,227,653 | US6,234,609 |
| US6,238,040 | US6,188,415 | US6,227,654 | US6,209,989 |
| US6,247,791 | US6,336,710 | US6,217,153 | US6,416,167 |
| US6,243,113 | US6,283,581 | US6,247,790 | US6,260,953 |
| US6,267,469 | US6,273,544 | US6,309,048 | US6,420,196 |
| US6,443,558 | US09/422,892 | US6,378,989 | US09/425,420 |
| US09/422,893 | US09/609,140 | US6,409,323 | US6,281,912 |
| US09/575,113 | US6,318,920 | US6,488,422 | US09/693,644 |
| US6,457,810 | US6,485,135 | US09/112,763 | US6,331,946 |
| US6,246,970 | US6,442,525 | US09/505,951 | US09/505,147 |
| US09/505,952 | US09/575,108 | US09/575,109 | US09/575,110 |
| US09/607,985 | US6,398,332 | US6,394,573 | US09/606,999 |
| US6,238,044 | US6,425,661 | US6,390,605 | US6,322,195 |
| US09/504,221 | US6,480,089 | US6,460,778 | US6,305,788 |
| US6,426,014 | US6,364,453 | US6,457,795 | US09/556,219 |
| US09/556,218 | US6,315,399 | US6,338,548 | US09/575,190 |
| US6,328,431 | US6,328,425 | US09/575,127 | US6,383,833 |
| US6,464,332 | US6,390,591 | US09/575,152 | US6,328,417 |
| US6,322,194 | US09/575,177 | US09/575,175 | US6,417,757 |
| US09/608,780 | US6,428,139 | US09/607,498 | US09/693,079 |
| US09/693,135 | US6,428,142 | US09/692,813 | US09/693,319 |
| US09/693,311 | US6,439,908 | US09/693,735 | PCT/AU98/00550 |
| PCT/AU00/ | PCT/AU00/00517 | PCT/AU00/00511 | PCT/AU00/00754 |
| 00516 | PCT/AU00/00756 | PCT/AU00/00757 | PCT/AU00/00095 |
| PCT/AU00/ | PCT/AU00/00338 | PCT/AU00/00339 | PCT/AU00/00340 |
| 00755 | PCT/AU00/00581 | PCT/AU00/00580 | PCT/AU00/00582 |
| PCT/AU00/ | PCT/AU00/00588 | PCT/AU00/00589 | PCT/AU00/00583 |
| 00172 | PCT/AU00/00590 | PCT/AU00/00591 | PCT/AU00/00592 |
| PCT/AU00/ | PCT/AU00/00585 | PCT/AU00/00586 | PCT/AU00/00749 |
| 00341 | PCT/AU00/00751 | PCT/AU00/00752 | PCT/AU01/01332 |
| PCT/AU00/ | PCT/AU00/01513 | PCT/AU00/01514 | PCT/AU00/01515 |
| 00587 | PCT/AU00/01517 | PCT/AU00/01512 | PCT/AU01/00502 |
| PCT/AU00/ | PCT/AU00/00333 | PCT/AU01/00141 | PCT/AU01/00139 |
| 00593 | PCT/AU00/00753 | PCT/AU01/01321 | PCT/AU01/01322 |
| PCT/AU00/ | PCT/AU00/00594 | PCT/AU00/00595 | PCT/AU00/00596 |
| 00584 | PCT/AU00/00598 | PCT/AU00/00741 | PCT/AU00/00742 |
| PCT/AU00/ | | | |
| 00750 | | | |
| PCT/AU01/ | | | |
| 01318 | | | |
| PCT/AU00/ | | | |
| 01516 | | | |
| PCT/AU02/ | | | |
| 01120 | | | |
| PCT/AU01/ | | | |
| 00140 | | | |
| PCT/AU01/ | | | |
| 01323 | | | |
| PCT/AU00/ | | | |
| 00597 | | | |

### BRIEF DESCRIPTION OF THE DRAWINGS

A preferred form of the present invention will now be described, by way of example only, with reference to the accompanying drawings, in which:

FIG. 1 is a schematic perspective illustration of a mouse having almost completed the printing of an image onto a page, the mouse being in accordance with the invention;

FIG. 2 is a schematic perspective illustration of the mouse;

FIG. 3 is a schematic inverted perspective illustration of the mouse;

FIG. 4 is a schematic inverted exploded perspective illustration of the mouse;

FIG. 5 is a plan view of the mouse;

FIG. 6 is a front elevational view of the mouse;

FIG. 7 is a side elevational view of the mouse;

FIG. 8 is an end elevational view of the mouse;

FIG. 9 is a schematic inverted plan view of the mouse;

FIG. 10 is a schematic cross-sectional elevational view of the mouse taken at X-X in FIG. 9;

FIG. 11 is a schematic cross-sectional end elevational view of the mouse taken at XI-XI in FIG. 9; and

FIG. 12 is a schematic perspective view of internal components of the mouse.

### DESCRIPTION OF THE PREFERRED EMBODIMENT

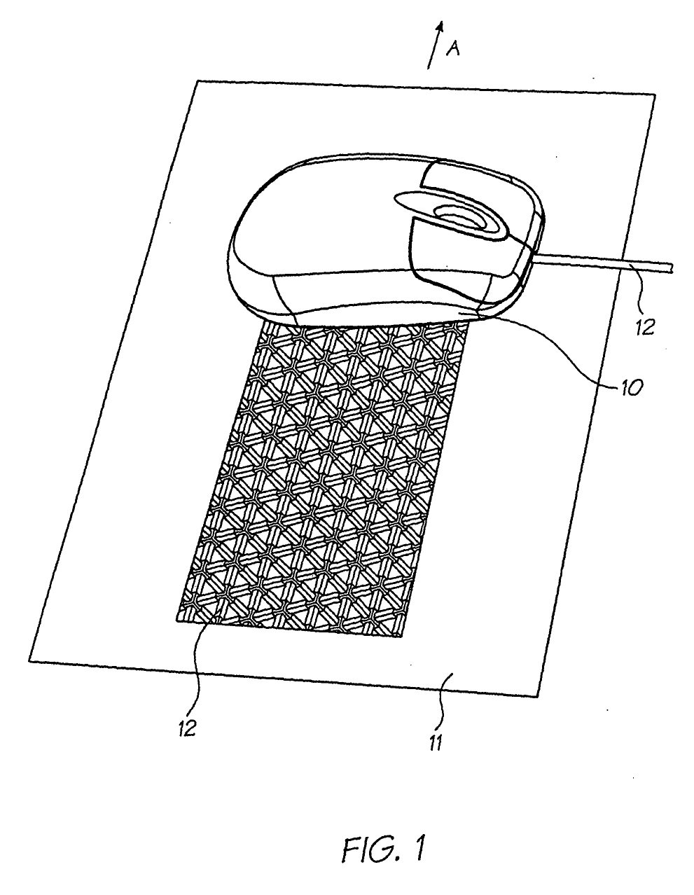

In FIG. 1 of the accompanying drawings there is schematically depicted a mouse 10 having almost completely traversed a page of print media 11 so as to print an image 12 thereon. Mouse 10 is connected to a computer via a universal serial bus (USB) cable 12, although any suitable data connection, including a wireless infrared or radio based connection, can be used instead.

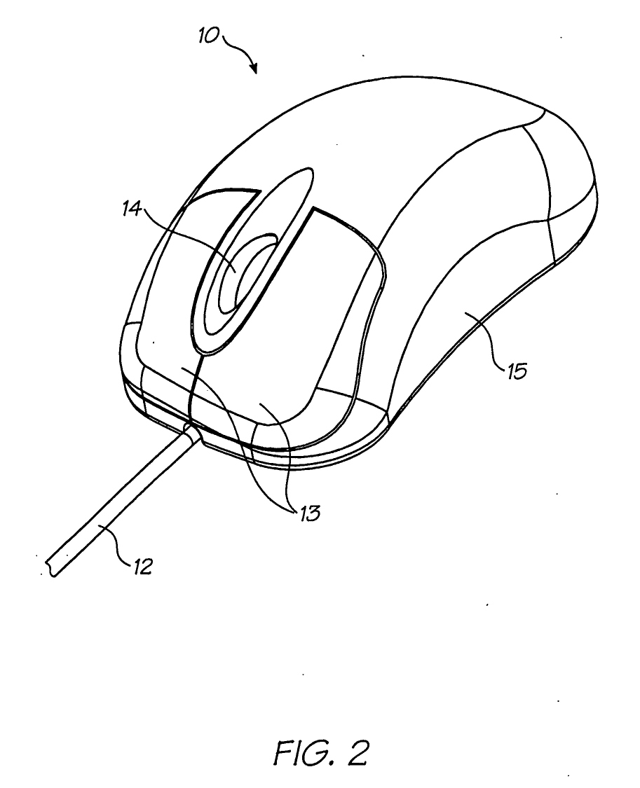

As shown in FIG. 2, the mouse 10 looks similar to a known mouse from above and includes a top molding 15, a pair of button moldings 13 and a scroll wheel/button 14 situated therebetween.

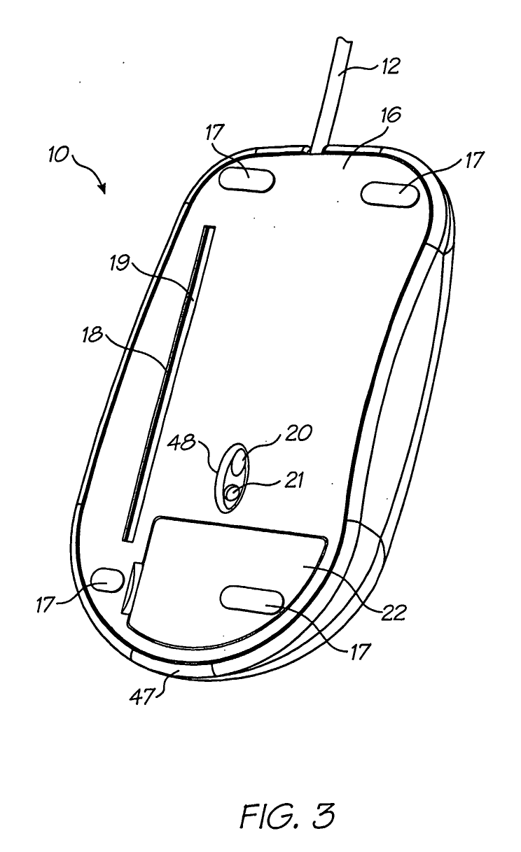

The underside of the mouse is shown in FIG. 3, including a base molding 16 to which the top molding 15 is attached. A number of slider pads 17 are attached to the base molding 16, thereby enabling the mouse to slide smoothly over a mouse pad or a sheet of print media.

A light pipe 20 emits light through an opening 48 so as to be reflected from a surface of a mouse pad or the print media and received by lens 21.

Also shown is a “MEMJET” printer chip 18 flanked by the slider pads 17. A mechanical capper device 19 caps the “MEMJET” chip 18 when printing is not in operation.

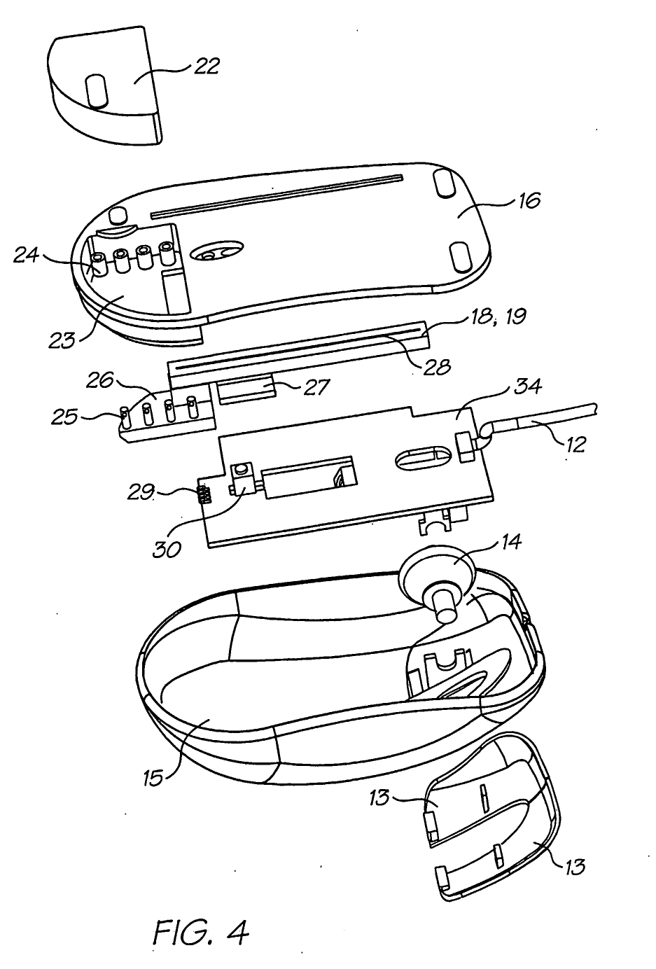

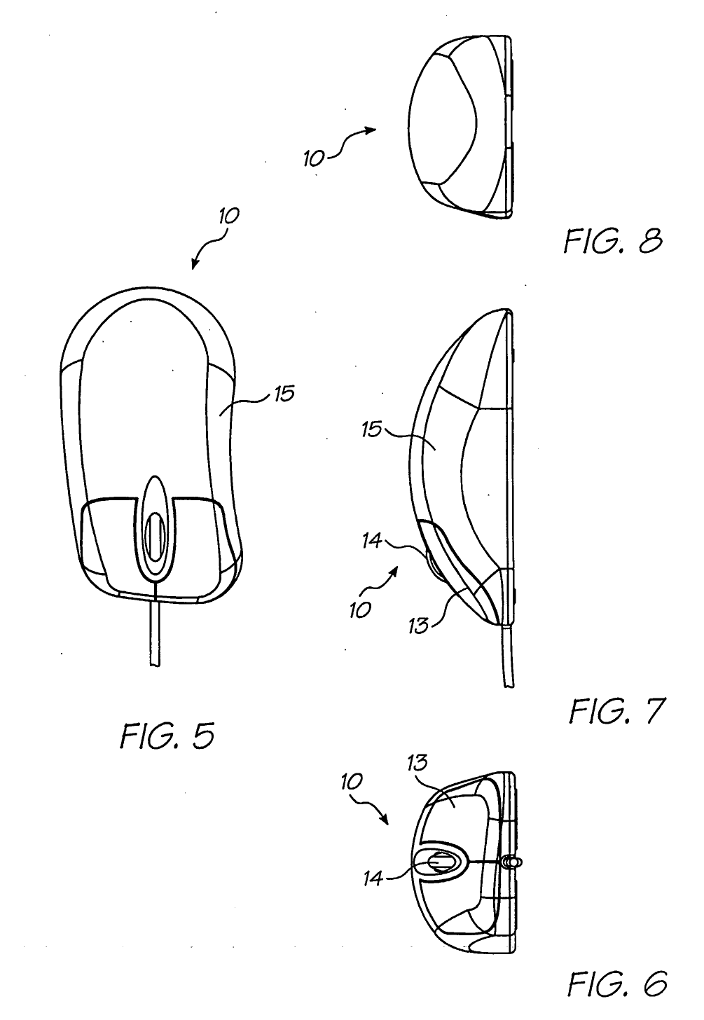

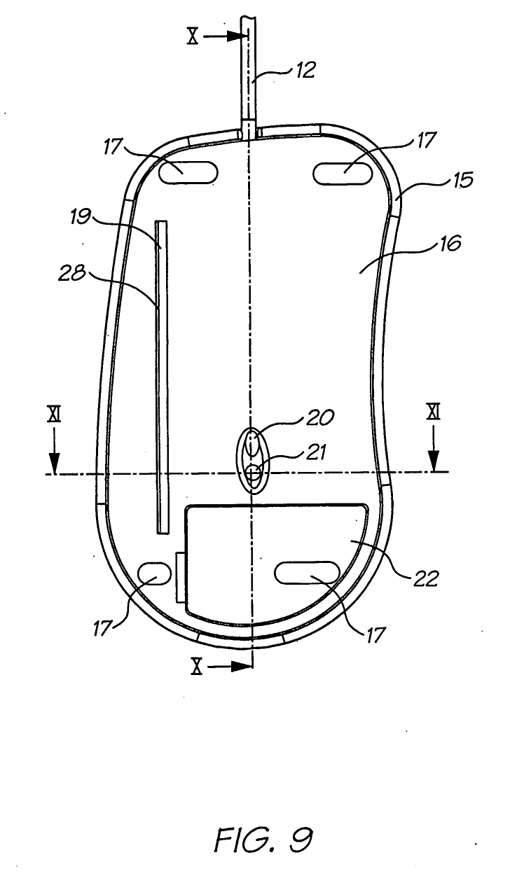

An ink cartridge 22 (FIG. 3) is received within an ink cartridge bay 23 (FIG. 4). A number of flexible collars 24 extend into the ink cartridge bay 23. A corresponding number of ink pins 25 projecting from an ink connector block 26 extend into the flexible collars 24 of the ink cartridge bay 23.

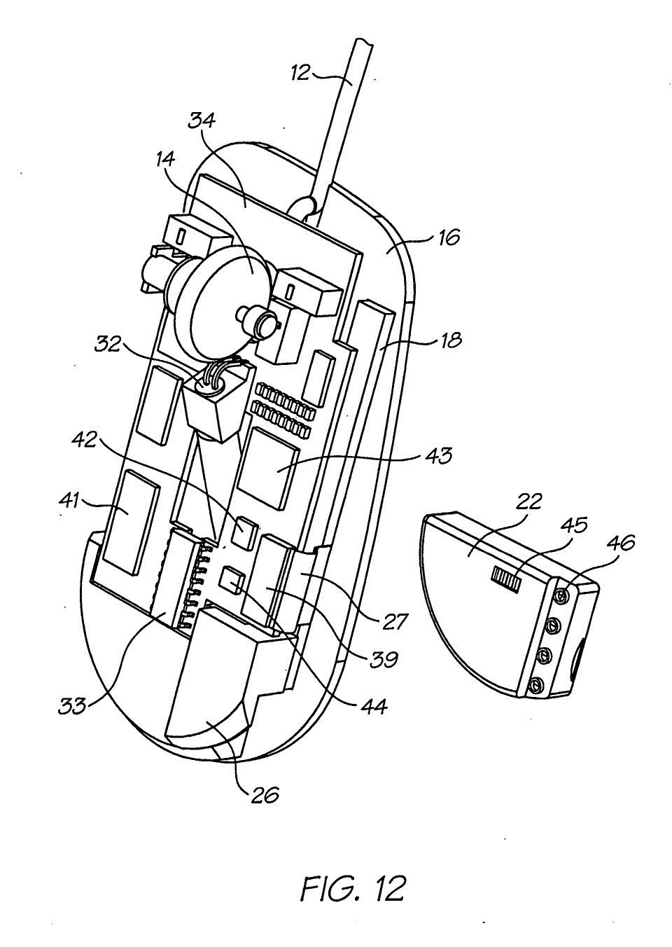

The ink connector block 26 conveys ink to the printhead 18. A flexible printed circuit board (PCB) 27 is connected to the printhead 18. A print chip 28 forms part of the printhead 18. A printed circuit board (PCB) 34 is housed within the mouse and has attached to it the USB cable 12. Also attached to the PCB 34 are QA chip contacts 29 adapted to contact a QA chip 45 (FIG. 12) on the ink cartridge 22.

An optical lens molding 30 is attached to the PCB 34 as shown.

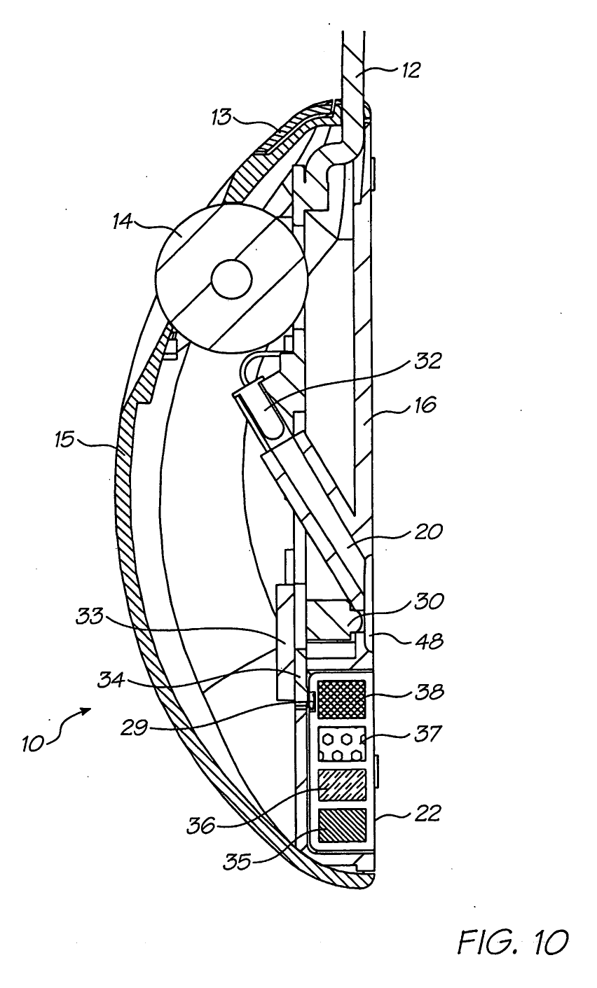

As shown in FIG. 10, there is located within the mouse 10 a high power/intensity light emitting diode (LED) 32. This emits light into the light pipe 20 for reflection from the surface and collection by the lens 30 to be focused on a CCD chip 33. The arrangement of LED 32, light pipe 20, lens 30 and the CCD chip 33 is known, and is used, for example, in the Microsoft “IntelliMouse® Explorer”.

As can be seen in the cross-sectional view in FIG. 10, the ink cartridge 22 comprises individual compartments for cyan ink 35, black ink 36, yellow ink 37 and magenta ink 38.

The construction and operation of scroll wheel and button 14 is also well known, and is used in, for example, Microsoft “IntelliMouse®” models.

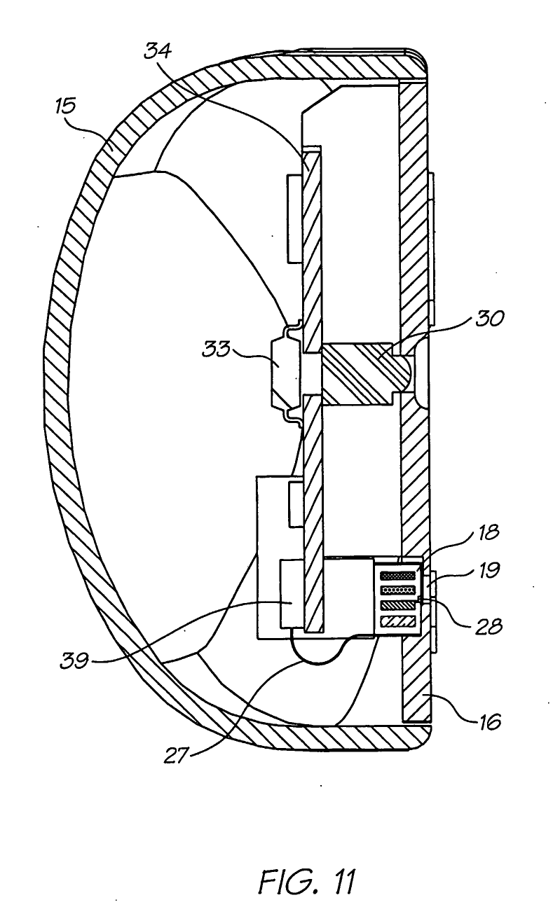

As shown in FIG. 11, the flexible PCB 27 is connected via flex connector 39 to the PCB 34. The flex PCB transmits power and data to the printhead 18 for operational control of the “MEMJET” print chip 28 and capper device 29.

Electronic components attached to the PCB 34 are shown in FIG. 12. These include the CCD chip 33, the print engine controller chip (PEC) 43, a dynamic random access memory (DRAM) chip 41 and a flash memory chip 42.

In use, the mouse can be manipulated by a user to control software in a conventional manner. That is, motion of the mouse upon a mouse pad or other surface results in corresponding movement of the pointer on a monitor. Clicking of the mouse buttons 13 results in conventional software effects.

In order to print an image 12 on a page, software can be activated by use of the mouse and/or a keyboard.

The mouse can then be manipulated by a user to traverse page 11 in a straight line indicated by arrow A in FIG. 1. Motion of the mouse 10 is detected via lens 21 by the CCD chip 33. Positional information can be transmitted via cable 12 to the computer, which in turn sends print control signals back down cable 12 to the mouse and printhead 18. More preferably however, the positional information read by CCD chip 33 is relayed directly via PCB 34 to the PEC chip 43 which takes graphic information from DRAM memory 41 and controls the printhead 18 so as to deposit ink onto media 11 depending on the speed at which the mouse is manipulated by the user to traverse the page.

In order to ensure a straight or “parallel” movement of the mouse across the page in the printing operation, its back edge 47 might be provided as a straight edge to bear against a straight ruler, for example, held in place by a user upon the print media 11. That is, the mouse can be drawn against an edge of a ruler for example to ensure correct, parallel printing in a direction normal to the longitudinal extent of the print chip 18. Smearing of ink directly after its deposit onto the print media 11 by slider pads 17 does not occur as the pads are located longitudinally outward of the print chip 18.

In an alternative embodiment (not shown), the printhead is configured to print coded data onto the media, preferably in an infrared ink that is substantially invisible to humans. It is particularly preferred that the coded data be printed in addition to other, visible data, such that a coded data reader can be used by a user to sense the coded data on the media even where there is visible printed information. Further information about the applicant's Netpage system incorporating such coded data reading and printing is disclosed in the patent applications and patents listed in the paragraph headed “Related Patent Applications and Patents”, at page 2, the contents of which are incorporated herein by way of reference.

It will be appreciated that various aspects of the printhead such as size, resolution, orientation relative to the mouse, number and type of printable inks and the like can be varied without departing from the spirit and scope of the invention. Although various aspects of the invention have been described with reference to a number of specific embodiments, it will be appreciated that the invention can be embodied in many other forms. It will further be understood that any reference herein to known prior art does not, unless the contrary indication appears, constitute an admission that such prior art is commonly known by those skilled in the art to which the invention relates.

1. A mouse pointing device comprising:
a housing;
a motion sensor mounted to the housing and serving to relay positional data from the device to a computer so as to effect motion of a graphic pointer on a monitor associated with the computer, and
a printer located within the housing and configured to receive print data from the computer, the printer being configured to print an image, based on the print data, onto print media external to said housing as the housing traverses said media, said motion sensor providing positional data of the housing relative to said print media to the printer during printing and,
an ink cartridge bay provided in the housing for receiving an ink cartridge in use to thereby supply ink to the printer, the housing including a number of flexible collars extending into the ink cartridge bay.

2. The device of claim 1, wherein the printer includes a drop-on-demand inkjet printhead including a plurality of ink ejection nozzles.

3. The device of claim 2, wherein the housing also includes a print controller including a computer processor into which said print data can be input and converted into a sequence of drop ejection control signals, said print controller operating said ink ejection nozzles in accordance with said drop ejection control signals to cause printing on said print media at a rate determined using a measured relative speed between the printhead and the print media.

4. The device of claim 1 wherein said motion sensor includes a light source to emit light onto a surface on which said device is used, and a lens through which light reflected from said surface passes to a CCD chip.

5. The device of claim 1, wherein the printer includes a printhead fabricated at least partially using microelectromechanical processes.

6. The device of claim 1, the ink cartridge including a number of compartments for respective ink colours, the ink cartridge being received by the cartridge bay in use.

7. The device of claim 6, the device further including a number of pins extending into the flexible collars, the pins being adapted to cooperate with respective compartments in the cartridge.

8. The device of claim 1, the housing including a number of slider pads adapted to allow the housing to slide over the print media.

9. The device of claim 1, the printer extending along the housing in a first direction, wherein in use the device is adapted to be moved in a second direction substantially normal to the first direction to effect printing.

10. The device of claim 9, the housing including slider pads being spaced from the printer in the first direction to thereby prevent smearing of deposited ink.
